(19) United States
(12) Patent Application Publication
(10) Pub. No.: US 2017/0132555 A1
(43) Pub. Date: May 11, 2017

(54) SEMI-AUTOMATED MACHINE LEARNING PROCESS TO MATCH WORK TO WORKER

(71) Applicant: Rolf Ritter, Miami, FL (US)

(72) Inventor: Rolf Ritter, Miami, FL (US)

(21) Appl. No.: 15/346,928

(22) Filed: Nov. 9, 2016

Related U.S. Application Data
(60) Provisional application No. 62/253,258, filed on Nov. 10, 2015.

(51) Int. Cl. G06Q 10/06; G06N 99/00

(52) U.S. Cl. CPC G06Q 10/063112; G06N 99/005; G06Q 10/06398

(57) ABSTRACT

Present invention discloses a semi-automated computer implemented system and method that in combination with human expertise assures the best suited available worker for a customer's project or task on any internet based platform. This invention provides for a database of vetted workers evaluated on various criteria and a list of standard works that are weighed against the requested work to determine project fit rate. It also, comprises of a software tool for the customer to specify the work and a machine-learning algorithm that will match the requested work to a standard work and propose the worker that best fits to the work. The system calculates project fit rate and worker suitability and based on it proposes if a fully automatic assignment of work to the worker is the best solution or a human has to assure the perfect assignment. This system aims at providing precise matching results in less time and reducing the transaction cost by continuously improving its own performance by critical evaluation.

### RELATED APPLICATION DATA

This application claims the priority to pending U.S. Provisional Application No. 62/253,258 filed on Nov. 10, 2015, which is hereby incorporated by reference in its entirety.

### TECHNICAL FIELD

The invention relates to the field of Electric Data Processing and Management of online working platforms. More specifically, the invention relates to a method and process for semi-automated matching of workers with tasks posted on an online working platform.

Online workplaces have become a popular mode of conducting business in the contemporary world. Existence of Company Profiles on many such online workplace forums has clearly indicated that the term ‘worker’ is no longer confined to the orthodox description of traditional on site employees, which is gradually changing in the sense that work is becoming more virtual and workers becoming more independent. Both the workers as well as work-givers have benefitted as a result thereof. However, if is their requirements which has paved way for innovation in this field. The paradigm shifting in the field has also paved way for research and innovation in this domain. As a result, many methods and processes have been invented to make these workplaces efficient as well as effective. One of the areas has been the search and shortlisting of workers based on their professional skills and expertise for a particular task.

Workers working in a similar field have a very thin line of difference between their work portfolios. It is practically impossible to select the right candidate just on the basis of using keywords based upon his/her field of expertise. A proper mechanism is needed to shortlist the candidates on the basis of their past performances and experience to enable an assignor to make an informed choice about his/her selection. This kind of a system not only ensures that a suitable candidate is selected according to the assignor's requirements, but also helps in developing a healthy competitive environment which ensures that the standard of work quality remains optimal by all professional standards. However, companies find it very difficult to implement the said process given the wide number of professionals operating in similar fields with almost similar expertise and experience. Presence of millions of highly capable and motivated workers in similar fields makes the process complicated. Assignors require a proper mechanism through which they can identify the right talent and assure themselves that they have identified a right candidate and thus can be trusted with the work.

Nevertheless, due to the identified complexities, the line of difference between workers often becomes very thin and shortlisting of best candidate becomes very complicated.

In the absence of proper mechanisms in place, assignors are left reliant heavily upon their own devices and have to go through long lists of potential candidates with only limited indications on their qualifications, fit for the project and trustworthiness. This leads to the situation that companies have to spend a lot of time and energy to filter, evaluate and select the right talent for them. Existing processes and mechanism known in the prior art rely heavily upon the keyword search mechanism which matches the posted description with the expertise of candidates. Albeit this filters the list by removing candidates which do not match the description for required expertise highlighted by the work assignor, but after one layer of filtering, they ultimately leave it to the assignor to select the candidate for himself from a group of many eligible candidates while there is a scope for further shortlisting. The final selection may thus not be fair and will discourage a better deserving candidate. Apart from this manual decision making with respect to the final step of selection leaves ground open for errors and prejudices. There may be a scenario that no human intervention is required to assign a task after the assignor has clearly identified his/her requirements and a suitable candidate already exists for that. Furthermore, databases as found in the prior art have a very limited group of keywords based upon certain predefined terminologies on the basis of which candidates can be shortlisted, but cannot be compared and evaluated automatically. Also, the terms that are not available in the database can't be searched even if they are indispensable to get the desired results.

Existing prior art has disclosed, processes that rely hugely upon the bidding mechanisms wherein the interested individuals post their willingness in the form of bids out of which one (or more) bids is selected and the work is assigned. The problem lies in the fact that the final decision rests with the assignor who can make selection even by disregarding a deserving bidder. The eligible workers thus lose their precious bids, which they have purchased from the platform offering online workplace.

No solution exists in the common knowledge that would allow an assignor to briefly describe its needs and have a solution do the rest for them, so they could delegate work easily and securely. Methods and processes persisting in the prior art for Consulting Based Solutions, where a consultant advises the customer on the right fit, and process to get to the desired results, are very expensive and very limited in their scope.

All other solutions on the market are self-service models that rely completely on the users to support the selection process. The customer only gets support through pre defined templates or categories to choose the work he wants to get done and can read evaluations, star ratings and past project comments to make a choice. Neither any sophisticated algorithm, nor any manual involvement is there to support the process which leaves non-experienced users to find a perfect match while triggering the risk of below standard match results and selection.

Present invention seeks to redress the aforesaid problems by providing a method and process that provides for a semi-automated match of workers to customer's requirements based on software algorithms to find the most suitable match worker for every customer work.

### SUMMARY OF THE INVENTION

Present invention is a software based technology that automatically matches worker's talent with jobs descriptions posted by an assignor on any internet based platform including, but not limited to, websites and mobile or PC based applications. The invention thus basically provides for a “Self Learning Software Algorithm” that combines a manual process to match work with workers. The technology, in combination with human intervention will semi-automatically provide a suitable worker from the online work portal's database itself. The objective of the invention is to minimize human intervention in the selection process of the most suitable worker out of a very large set of potential workers for a job posted online. The goal of the invention is to reduce the transaction cost involved in finding the most suitable worker—as per, professional standards, including but not limited, to worker's qualifications, work ethics, and cost for a given task. As a result, this benefits the worker by finding work for which he or she is well qualified, the customer benefits by achieving the desired work result, and the overall economy benefits through reduced friction and waste involved in labour vetting, job satisfaction, quality of task results. In addition to reducing the transaction cost in matching work to workers, increased automation reduces bias and unnecessary, non-productive time consumption.

It is also the objective of present invention to protect the interests of industrious workers who are often deprived of work despite having required prior experience and resources to complete a job more effectively than any other candidate.

The invention attains the aforesaid objectives through a unique process which provides for certain software algorithms that work in tandem with human involvement to achieve better results than what is achieved through a purely machine or a pure human approach. The core components of the inventions comprise of a database of vetted workers evaluated on various attributes; a list of standard jobs; a software tool for the customer to specify the work and a semi-automated machine-learning algorithm that will (a) match requested work to a stereotypical job, (b) propose the worker that best fits to this stereotypical job, (c) through a feedback loop continuously improve its own performance in matching work to workers, thereby reducing transaction cost.

Based on the project fit (distance between the requested work and the stereotype) and the worker suitability (fit between worker performance and stereotypical job), the system will decide whether a fully automatic assignment is the best solution (project fit and worker suitability are above a given threshold) or if a human has to assure the perfect fit. The system learns project fit based on attributes that define work and human classification. The system learns worker suitability based on attributes that define work, the worker, and feedback from past experience both within the system and from, external sources. The system may also draw on data from external sources, such as publicly available or worker-provided information from social media sites, like LinkedIn, and expert communities, like Stackoverflow. With increased volume and with the benefit of the human intervention a higher percentage of customer projects will have almost perfect fit with stereotypical jobs and a higher percentage of workers will have almost perfect fit for those jobs, allowing the presented invention to provide ever better matches between work and workers in the system and higher quality results with relatively lower intervention.

### BRIEF DESCRIPTION OF DRAWINGS

The nature and scope of the present invention will be better understood from the accompanying drawings, which are by way of illustration of a preferred embodiment and not by way of any sort of limitation. In the accompanying drawings:

FIG. 1 is a schematic diagram showing some major components of the invention and their association with the internet.

FIG. 2 is a schematic diagram showing the overview of the present invention elaborating all major steps and embodiments required to carry out the process.

FIG. 3 is a schematic diagram drawn in the form of a flowchart explaining the process of internal matching of a new work with Standard Work definitions.

FIG. 4 is a schematic diagram drawn in the form of a flowchart explaining the step of manual matching of a new work with Standard Work definitions.

FIG. 5 is a schematic diagram drawn in the form of a flowchart explaining the step of matching workers to Standard Work Definitions in cases of partial matching between work and standard work definitions.

FIG. 6 is a schematic diagram showing the process of matching a worker with a standard work definition.

FIG. 7 is a schematic diagram drawn in the form of a flowchart explaining the step of matching worker to a new work and assigning him with the task.

### DETAILED DESCRIPTION

Having described the main features of the invention above, a brief and non-limiting description of a preferred embodiment will be given in the following paragraphs with reference to the accompanying drawings.

In all the figures, like reference numerals represent, like features. Further, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding the fact that numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes, plural reference unless the context clearly dictates otherwise. Also, as used in the description herein, the meaning of includes “in” and “on” unless the context clearly dictates otherwise. All through the specification, the technical terms and abbreviations are to be interpreted in the broadest sense of the respective terms, and include all similar items in the field known by other terms, as may be clear to persons skilled in art.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”, “for example”, “for instance”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

The present invention is a process that implements software based technology along with human assistance to ensure the best possible worker match for a customer work, job or task posted on an online working platform. The core components of the invention comprises of a software capture tool for the user to specify the required work in detail; a database of standard work definitions; a database of vetted workers evaluated on the basis of worker's qualifications, work ethics, cost, a detailed vetting process, past work and other suitable attributes; and a semi-automated machine-learning algorithm that will 1) match requested new work to the standard work definitions to calculate the project fit rate, 2) match the vetted workers against the standard work definitions to calculate the worker suitability and propose the worker that best fits to this stereotypical job, 3) through a feedback loop continuously improve the evaluation and matching of work to workers. On the basis of similarity in terms of ‘Project fit’, and the “worker suitability fit rate”, i.e., the fit between a worker and the standard work definition the system will decide whether a fully automatic fit is the best solution or if a human has to assure the perfect fit. The process of human intervention to match new work to standard work definitions takes place when the system learns a fully automatic assignment of a standard work definition to a new work isn't the best suited option.

The core components of this invention further comprises of, a capture tool to vet or evaluate new workers that signs up to the platform; a semi-automated machine-learning algorithm to match the new vetted workers to a new work; a process of human intervention to match worker to a new work in the event no vetted worker could be assigned to the new work solely through the algorithm; a method of evaluating workers on a regular basis through the system implementation and assistance of platform employee.

On a brief account of the functioning of the disclosed components in the light of the invention, the working process comprises the step of allowing users to specify the required work detail with the help of an interactive capture tool that will trigger a new filter with a new set of possible answers every time in response to the choice of the user made in the prior filter. Next follows comparing and matching new work to the Standard Work definitions to allow the match of work with workers, to define algorithms to decide when a human intervention is needed to improve the result of matching the new work to the standard work definition, to calculate worker suitability by defining algorithms to assign newly vetted workers to the standard work definition or to a new work, mechanism for updating standard work definitions database that improves the quality of the results by increasing the volume of transactions that are managed through the system and allotment of work to workers.

In order to execute a perfect match, the work needs to be defined in a way that would facilitate assignment of a suitable worker to the work, followed by comparing the work definition specified by the customer with the standard work definition pre-existing in the database. The vetting of customer task against the standard work definition can result in three possible status, namely:
1) Perfect Match: for this status, the work gets automatically classified to that standard work definition it is vetted against.
2) Partial Match: for this status, the semi-automated method comes to the play, a platform employee analyses the customer work definition and either clarifies a way that it becomes a perfect match or decides to create a new standard wok definition.
3) No Match: same procedure follows as status 2 for partial match.

The steps included in the process and their working methods are elucidated in the various embodiments of the present invention.

The system provides a work forum may be hosted on a server connected to the internet. In this embodiment, the work forum may be accessed through a computer system like a laptop, a tablet, a Personal Computer, a Phablet or a mobile phone or any other device that permits data sharing and internet connectivity. The work forum has a database that consists of the details about workers, their past activities and information about earlier job descriptions, evaluations made by the platform employees and all other relevant information that is necessary for the purpose of execution of the invented process. The invention can function in any information technology environment and internet being just one of them The stored data is even available offline and it is open for the users to access the invention while not being connected with the internet also.

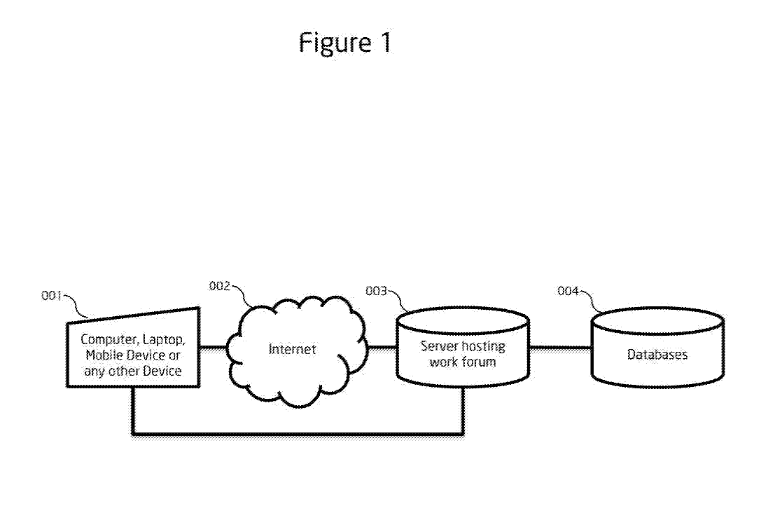

FIG. 1 a diagram showing important components of the system set-up. The information stored in the databases 004 is available to the Server 003 hosting the work forum and may be accessible via websites or applications available on any electronic device 001 that supports internet 002.

Matching Newly Posted Job Descriptions with Standard Work Definitions

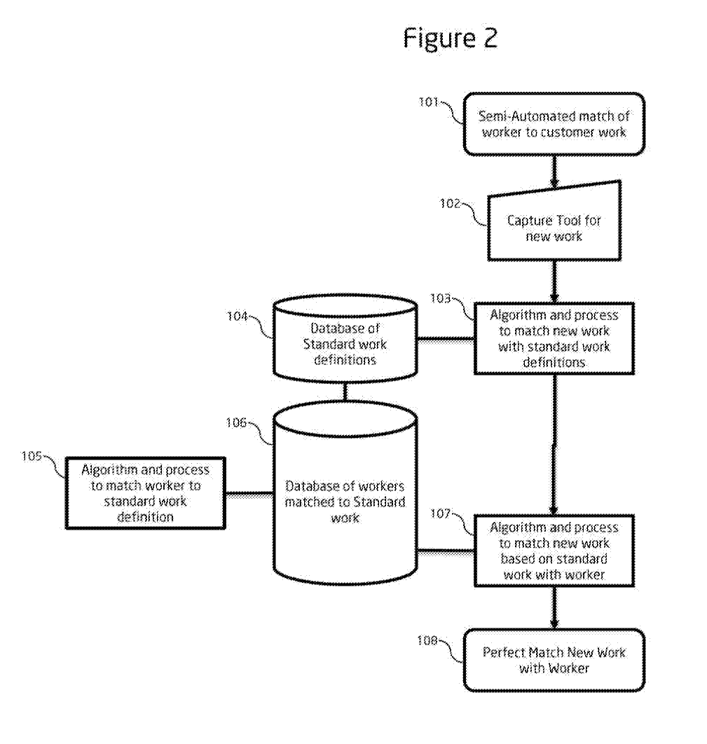

FIG. 2 is an overview of the method and system comprising of the present invention. The invention provides for semi-automated match of workers to job postings made by the customers of the relevant online forum 101. A software capture tool captures the newly posted work 102 and proposes work definition every time a user is defining a new work. This tool triggers a new filter and propose new set of possible answers every time in response to the choice of the user made in the prior filter. The number of filters will remain flexible depending upon the type of work. This enables the user to choose from the presented possibilities or add a comment at every level. If the user doesn't choose any of the presented possibilities, no further filters will be displayed to him and the new work will be assigned to platform employee for its necessary assistance in assignment of the task. The new work is then functioned through an algorithm 103 that matches the newly posted work with standard work definitions stored in the database of standard work definitions 104 and calculate a project fit rate. Based on the user specification if the new posted work is found to be a perfect fit for it to match with a standard work definition, a unique number of the standard work definition is assigned to the new posted work. In some instance, the algorithm may be able to assign the standard work definition based on partial specifications in other cases only based on full specification. In the next step, an algorithm then processes to match new work identified in the first step with the worker 107. In order to do so, an algorithm matches a suitable worker 105 from a database of workers 106 to the standard work definition found on the basis of level of similarity assessed. In this way, a perfect match for new job is identified 108. Besides, based on the user specification, if the algorithm is not able to assign a standard work definition to the new work project or a partial match is made out, the new work project will automatically be assigned to a platform employee for its further persuasion of matching and assigning the new work.

Matching of Newly Posted Job Descriptions with Standard Work Definitions

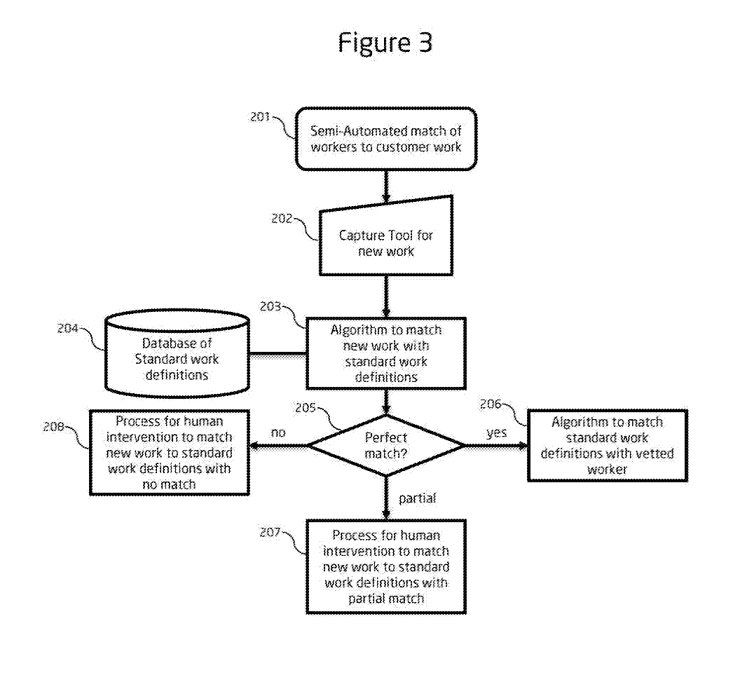

FIG. 3 is a diagram showing the mechanism of matching new work to standard work definitions proposed in the present invention 201. The new work posted on the work portal is captured through a capture tool 202 and is sent for matching in the first step of the process. In this embodiment of the invention, the system provides for a software algorithm that matches new work with already existing standard work definitions 203 that are standardized and stored in a database 204 after new work is posted on the working portal. The system calculates 205 similarity in terms of project fitness based on various criterions including, but not limited to, keywords, customer industry, budget and duration. If the level of similarity or project fitness between the newly posted and existing standard work definitions exceeds a predefined threshold, the match is recorded as perfect 206, the system will categorize the project with the same project code to which it has been found similar to. The process will then move on in the second step where standard work definitions will be vetted against the identified worker through a separate algorithm.

If the project fitness between the newly posted and existing standard work definitions does not meet the threshold for a perfect match but exceeds the threshold for a partial match 207, the system will propose the project, as similar and send it to the platform's employee to redefine the work to match an existing standard work definition or to adapt an existing standard work definition or to create anew standard work definition.

If the project fitness between the newly posted and existing standard work. definitions is below the threshold for even a partial match, the system will send the work description to a platform employee to create a new standard work definition 208.

Match New Work to Standard Work Definitions with No Match:

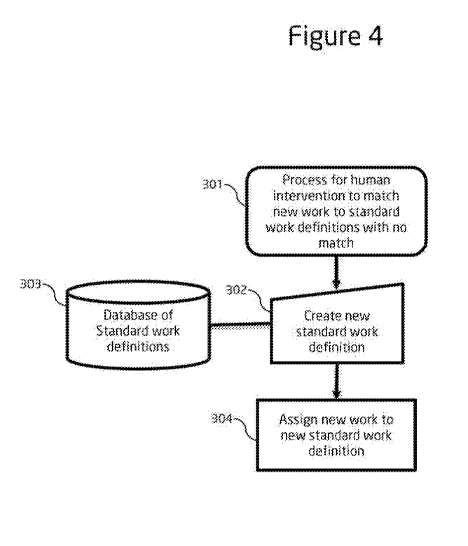

FIG. 4 is a diagram, illustrating how work that is not matched to a standard work definition is handled in the present invention 301. If the project fit rate between the newly posted and existing standard work definitions is below the threshold for a partial match, the platform employee will receive the work order to assign new work to a standard work definition. Based on the comments and specifications inputted by the user for the new work, the platform employee has certain options to resort with, which without limitation includes completing the new work specification so that the system can then assign it to a standard work definition, can clarify the specification further with the user so that the work can sufficiently be assigned to a standard work definition, can adapt a standard work definition to match with the new work specification, create a new standard work definition 302 in the database 303 for the new work, any combination of the of the said options or can altogether reject the new work informing the user that the task is outside the scope of platform. For example, a Platform employee therein either redefines the work to match to a standard work definition or creates a new standard project definition in the database. In future any work which failed to meet the threshold will then be assigned to this new work definition 304.

The process flows in a manner that at the end the new work is either assigned to a standard work definition or the new work is rejected by the platform employee. For future reference, while rejecting the work the platform will keep a record of rejected new work supplementing reason for the rejection. In this procedure the system will track the changes or any modifications made by the platform employee at the same time it will keep a version of the new work specification that was made by the user.

### Allotment of Partially Similar or Dissimilar Project Descriptions by Platform Employees

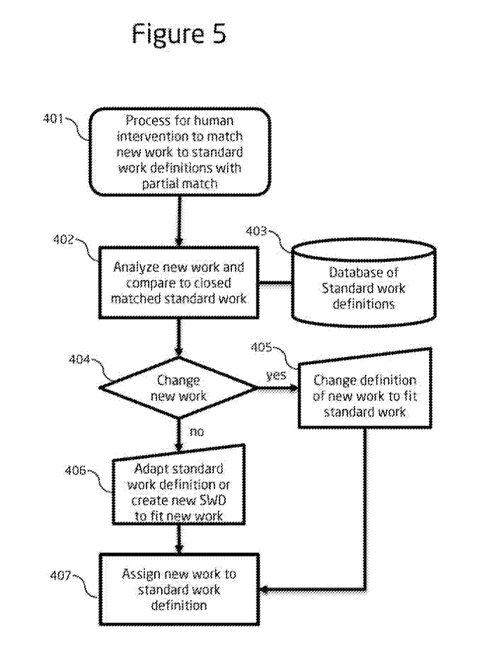

FIG. 5 is a diagram illustrating how work that is partially matched to a standard work definition is handled in the present invention 401. If the project fitness between the newly posted work and existing standard work definitions is below the threshold for a perfect match but exceeds the threshold for a partial match, the system will propose the project, to a similar standard work definition and send it to the platform's employee for intervention. The platform employee will examine the job description and if he finds that prima facie, there is a close match, the employee will examine the new project description 402 in contrast with the existing standard work definitions in the database 403 and either change or make variations in the work descriptions 404 so as to make it in consonance with the existing standard work definition 405. In case there is no close match found, the employee will either adapt an existing standard work definition or will create a new category for the standard work definition, update the existing standard work description database with the new category and will assign new work to a new category in accordance with new standard work definition so that the requested work meets the project fitness criteria 406. Finally, the employee assigns the requested work to the suitable work definition 407.

### Matching of Workers to Standard Work Definitions:

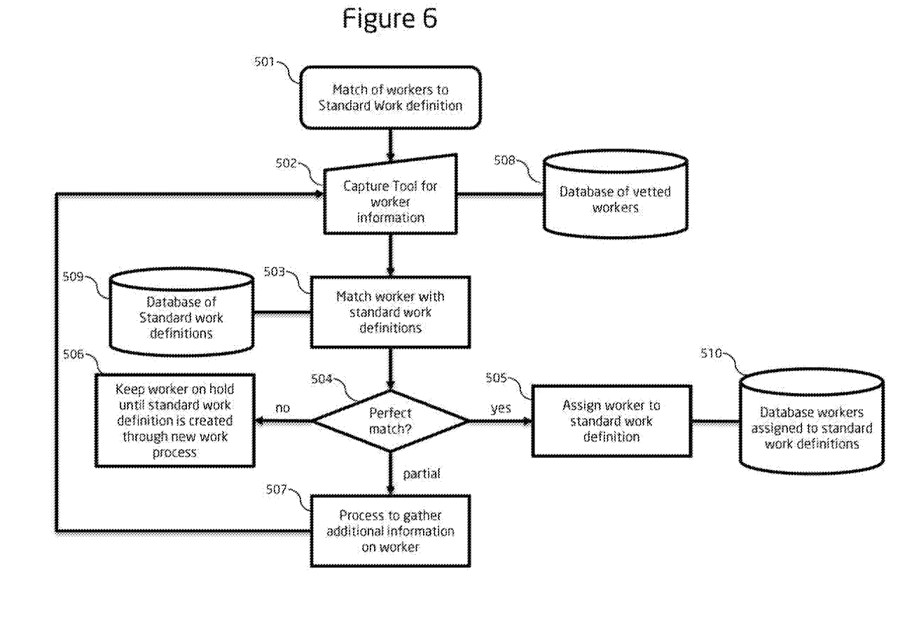

FIG. 6 is a diagram showing how workers are assigned to standard work definitions in the present invention 501. After newly posted work descriptions are matched or categorized in light of the prior existing Standard Work Definitions as per the earlier steps, workers are matched to the standard work definitions. The system has a database that keeps information about vetted workers 508. With the help of a capture tool 502 both employees and workers can update worker information during the process of vetting of a worker.

Every worker that signs up to the platform and wants to get enrolled for projects will be thoroughly vetted by the platform employee based on the information they provide. Based on the vetting process and the profile of the worker thee algorithm will assign standard work definitions to the worker (defined in a database 509) for which he/she is qualified according to their skills, area of expertise or any other relevant criteria 503. Depending on the description of the standard work definition the algorithm will assign the worker with a status of either “Assigned”, “Assigned and to be reviewed after first project by platform employee or to be validated by platform employee”. If the perfect match of work and worker is found 504, the worker is assigned to the standard work definition 505 and the worker database is accordingly updated for future references 510. If no perfect match is found, the worker is kept on hold until a standard work definition has been created through new work process 506. If only a partial match is found, efforts are made to gather more information about the worker and vetting process is repeated once again 507. But if despite repeated attempts, a perfect match is not found, the worker will be put on hold for future references. The algorithm periodically process the database to update the worker database according to the work it is qualified for, this in return assist to clarify and process the project fitness better in future. Due to this periodical assessment, a change or updation in the database can MOM or less occur on account of change in the profile of the worker, change in the standard work definition, reviews and feedbacks reflected in the system and any other criteria.

At the end of this process, a new qualifying standard work definition can be added to the worker profile or existing standard work definition can be removed from the profile. This process shall have no impact on the work the worker is already assigned to.

### Match Worker to New Work:

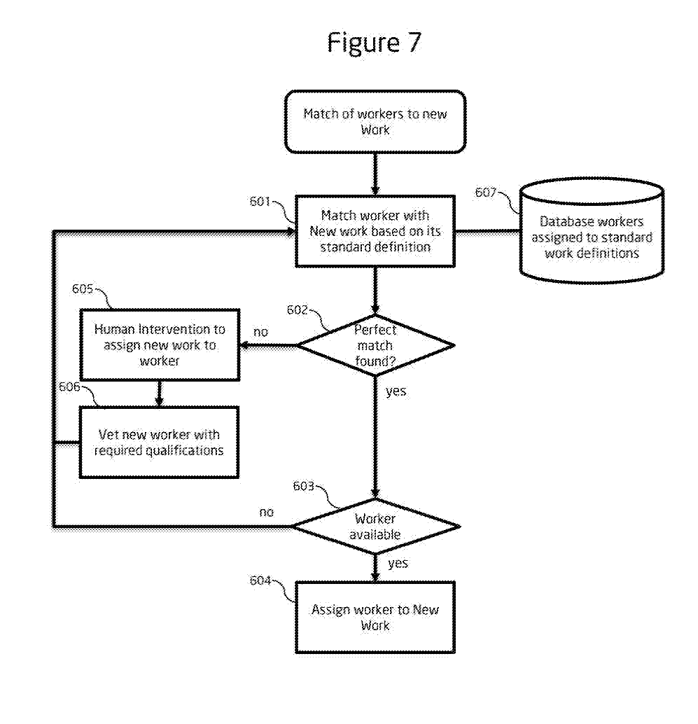

FIG. 7 is a diagram showing the step of matching workers to new work in the context of the present invention 601. In this step, it is already known that every new work at first will be assigned a perfectly matched standard work definition, either through the system algorithm or human intervention. Based on this definition, workers are retrieved from the database 607 in descending, order of worker suitability. If a perfect match (i.e., worker suitability exceeds perfect match threshold) is found 602 and the worker is available 603, the system automatically assigns the new work to be done by the selected worker 604. If the perfect match is found but the worker is not available 603, the next most suitable candidate is retrieved from the database 601. This process will repeat until a suitable, available worker is found or the database of candidates exceeding the perfect match threshold is exhausted, in which case a platform employee is notified of this exception 605. A platform employee manually reviews the relevant facts to start the vetting process of a new worker 606. Once a new worker has been vetted, he or she are added to the database 607 and the process is restarted for this work item 601.

In a further detailed explanation of this step, a new work may have additional criteria that fits with all type of standard work definition. A standard work definition many have one or multiple vetted workers assigned to it. Likewise, a standard work definition may have no vetted workers assigned against it which in turn goes to the platform employee who assigns a vetted worker first to a standard work, definition and then through the algorithm to the new work. In the event, one vetted worker is assigned to the standard work definition the algorithm begin with verifying if the vetted worker is qualified to work on the designated new work. This verification will be based on the criteria provided in the new work, the standard work definition and the qualification of the vetted worker. If certainly the vetted worker is found suitable for this new work then the algorithm will verify the specific user's preferences against the vetted worker. If the outcome of all the foregoing are favourable, the algorithm will assign the vetted worker to the new work and inform both the customer and the vetted worker about the assignment. In the contrasting situation, the algorithm will notify the platform employee that no suitable match for new work could be found.

Similarly, if multiple vetted workers are assigned to a standard work definition, the workers are retrieved from the database in descending order of work suitability, meaning the algorithm will commence search from the prior work history of the customer (if any) and identify the worker mostly preferred by or has worked with the customer for this standard work definition. The System may filter the work suitability based on the non-limiting categories such as best prise, total customer review, platform employee score, total time worked for this customer (if existing), total time put for other customers. If yet the search result identifies more than one vetted worker, the worker suitability will be, determined in alphabetical order basis. The highlighted filter categories will also be taken into consideration if at all no customer prior history against a standard work definition or a vetted worker is found. The categories may be applied in a hierarchical form, for instance, if a vetted worker is found qualified for the first category, he will be assigned to the work otherwise a weighted average score will be considered wherein, the worker with the highest weighted average score from all the categories will be preferred and assigned to the work.

### Process for Human Intervention to Match Worker to New Work

A platform employee will be notified and assigned to match worker suitability to a new work in the event no vetted worker could be assigned to the new work through the algorithm. The platform employee will search for a suitable worker to be assigned to a standard work definition (as discussed at the previous step) which in turn will be assigned to the new work by the algorithm. As described a direct assignment of vetted worker to a new work is not possible. A qualified vetted worker will always at first be assigned to a standard work definition and through such assignment become available for the new work. This search for the worker suitability will be based on the information provided under the new work, the standard work definition and the qualifications of vetted workers already assigned to the standard work definition. While this process of assignment by the platform employee, the employee can execute or choose to execute the following non exhaustive list of the possible options and combinations thereof:
The platform employee may issue a temporary acceptance to the vetted workers found to be suitable for this standard work definition but are not accepted by the customer. The issuance of temporary acceptance will remain subjected upon the reason for non-acceptance.
The platform employee may choose to include or oversight additional criterions to the new work as an effect to assign a probationer vetted worker to the standard work definition, if the platform employee deems such worker best suited for the assigned work.
Can assign workers vetted for similar standard work definition either on a temporary or on a definitive basis.
Can assign the workers on a temporary or on a definitive basis who are vetted against other standard work definition but are also deemed qualified for this standard work definition.
Search un-vetted workers in the database that seem to have the right qualifications and start the vetting process. Once they are vetted and accepted as vetted workers they will be assigned to the standard work definition and might be accepted on a temporary or on a definitive basis.
Staff new workers to sign up to the platform and start vetting process as described above
Review the designated standard work definition for the new work and if deemed appropriate assign a different standard work definition to the new work and then allow the algorithm to conduct the assignment of vetted workers to the new work as discussed in the foregoing.
Any other possibility or combination thereof which will assure an effective solution for the customer/assignor of the new work.

Upon signing up to the platform every worker has to create a profile in the system providing adequate information about their capabilities and qualifications. Such information without limitation includes information on price, availability, language skills, communication tools, time zone and any other information useful to support the vetting process and the matching process of the worker with potential new work. The information fed by the worker are considered one part of the detailed information for the vetting process. Depending on these worker provided information, during the vetting process, the platform employee will validate the worker's qualification, test the worker against the type of qualified works and accordingly add further information to the subject profile that are relevant for the assignment process. While the workers are allowed to change only specific fields of their information, the platform employee is allowed to change any field in the worker's profile in flutherance of the vetting process. Additionally, some fields might not be visible to the worker, but only to the platform employee. For instance, the worker can propose the type of standard work definition he deems himself to be qualified for. The worker can add multiple standard work definitions to his profile as well as can change or delete any standard work definition from his profile. A platform employee will then validate the standard work definitions the workers has chosen and he can add additional restrictions, work definitions and alike to the profile. Depending on the pre-set criteria and through manual intervention by the platform employee, any added standard work definition by the worker can be changed, revoked and suspended. Besides, the platform employee at the backend can limit the worker to specific standard work definitions depending on complexity, quantity or price. But the worker doesn't have access to view the limitations made by the platform employee at the backend. In this manner the system maintains a database of vetted workers. Any transaction executed with a customer in the platform will be automatically added to the worker's profile.

Based on the database of vetted workers maintained by the system, an ongoing vetting process will be commenced by the platform employee. The vetting process will begin at the stage a worker signs up to the platform and based on the qualification and working experiences both before and after signing up at the platform the worker will be continually vetted. This continual vetting process will enhance the quality of automated matching/assignment of qualified worker to work. In the vetting process by the platform employee, the following non-exhaustive criteria will be verified against the worker:
Qualification
Work ethics
Language and communication skills
Communication technology
Availability
References
Test work
Requested standard work definitions a worker would like to be considered for
Or any other criteria relevant for the vetting process and the algorithm to assign a worker to new work

Qualification to a worker will be assigned based upon the required qualification derived from the capture tool for new work 102. The same capture tool will also assist in assigning qualifications to worker. A worker can have multiple qualifications ranging from a hierarchical pool of qualification. And in that way an assignment can happen at any level of the hierarchical set of qualification specified for standard work definitions. For instance, if a worker is found qualified for a level of qualification from the hierarchical set of qualification definition, it would be imply that he qualifies for all underlining set of qualification definition lower to the subject qualification. Worker proposed qualification for a new work will be taken into consideration only when such proposal have been verified and accepted by the platform employee. If in the later course a worker propose a new qualification under his profile when he has already been vetted under the previous qualifications, under such circumstance the platform employee will start the described vetting process 606 for the new qualification as soon as it received notification of such proposal.

In another embodiment, Workers are continually evaluated based on both platform feedback as well as by all parties' involved and using data from external sources upon the information captured by the system. In other words, this system inculcates a comprehensive and error free evaluation by combining feedback of several entities namely customer/work assignors, platform employees, machine algorithm, self-evaluation by the worker himself and the other workers the subject worker shares the work with. All such entities will have different criterions for evaluating and their combined feedback will determine the workers overall ratings. This will also determine their suitability ratings for different standard work definitions over time. The suitability rating mechanism becomes increasingly accurate as more and more work goes through the system, resulting in higher numbers of perfect matches in the first round. This allows qualified team members to focus their time on new kind of work or work variants and new talent on the platform. The evaluating criterions can change depending on type of work the worker is qualified for, price level of worker, number of hours worked through the system, history of evaluations in the platform and any other criteria. A hierarchical structure is to be followed for evaluating on a particular criteria of interest. The system evaluation at first will be performed if possible. Next to this a platform employee will perform the evaluation of the criteria the employee is capable of attaining. Later this, the customer and other workers will evaluate for criteria they are capable to evaluate on. This comprehensive evaluation will notify the potential loop holes of the worker which in turn will assist the platform to conduct a better assignment of future projects, flexibility in regard to customer feedback will be taken into account for accessing overall ratings. In order to generate a reflection of the worker on his/her performance and to get additional feedback both on his/her capability to self-assess, the worker as well self-evaluate himself. Outcome of such comprehensive critical evaluations can result in the suspension of certain assignments of workers or from standard work definitions, the un-vetting of workers or the complete suspension from the platform. The evaluation system is a key tool to assure the continued acceptance as a vetted worker in the platform and to increase the quality of the work done. A worker can be assigned to more than one standard work definition. Not all workers will be the perfect fit for a certain definition and depending on the work history, experience, price level and other criteria the fit will change over time. The standard work definitions are assembled in a hierarchical manner, in a way that if a worker gets qualified for a higher level of qualification it will imply that he is qualified or suitable for rail lower level of qualification as well.

In another embodiment, the capture tool for new work 102 and for vetting new worker to the platform 606 may make proposals standard work definition and stereotypical worker definitions, respectively, while the user/customer is defining his work or profile at the first stage 102. Additionally, it may allow multiple choice capture tool to assist the customer/user in defining the criterions at its best. The system may further adopt manual process to let the user define standard work definition based on its new work definition. It may user process to match new work with standard work definition.

In an alternative embodiment, the system may, allow new workers to define new standard work definition and assign such standard work definition if no good match is made out through the process of the system. Optionally, there ma be manual processes to match new work to worker without having a standard work definition assigned to it.

In another embodiment, there may be implementation of process to add multiple new work to one single new work so that with additional scale it can better be assigned to standard work definition. Similarly, a manual process or algorithm may be adopted to reject a new work if no worker can be assigned to the same. Further, in the event a standard work definition cannot be assigned, the system may further employ algorithm to automatically send new work back to user seeking further clarification. This feature can also be employed on manual process. For repetitive work that has once been assigned to a worker by the same user, in future course the algorithm may accept, direct assignment of similar new work to the same worker.

The invention thus combines the potential of software algorithms and machine learning with human intervention to achieve results superior to both purely human and fully automatic approaches. The process also provides for defining algorithms to decide when a human intervention is needed to improve the result.

All these steps and features thus allow high quality matching results of work with workers at much less time spent by the customer to assure the matching, less time effort spent by human intervention to achieve those superior results, a high degree of automation through the combination of software algorithms with human intervention, the possibility to delegate even small work tasks to workers in a low cost process, the solution for business to take advantage of the global virtual freelancer workforce without the need to take the risks and time involved with other solutions and to reduce the field of potential candidates for work to one best fit worker for the customer to choose. This invention can be'used for any other process to match supply with demand of any product or service based on complex demand description and a large multitude of supply to satisfy this demand. Depending on the complexity of the process and the capability to develop intelligent algorithms and through the combination of machine learning, algorithms and human intervention superior results than today could be achieved.

Available solutions on the market are self-service models which are more dependent on manual processes. The customer only gets support through pre-defined templates or categories to choose the work he wants to get done and can read evaluations, star ratings and past project comments to take a choice. This leaves a non-experienced customer or worker to resort to high cost, risk and low probability method to achieve a perfect match. Implementation of this kind of semi-automated system that effectively enables both automation and human intervention to take a perfect choice has seldom been thought of.

1. A semi-automated method for assigning suitable worker to a requested work project on an online platform, the method comprising the steps of:
a. Allowing users to define work description in detail;
b. Maintaining a database of standard work definitions and workers vetted on various attributes while signing up with the platform;
c. Assigning work to workers with a semi-automated system that assigns requested work to a standard work definition, calculates the distance between project fit rate and worker suitability and thereby decides if a fully automatic allotment of work to worker is the best solution or a human intervention is necessary to assure the perfect match;
d. By means of a feedback loop continuously evaluate workers to improve its own performance in matching work to workers.

2. The method as stated in claim 1, where the semi-automated system includes assignment through machine learning algorithms, manually through platform employees or both.

3. The method as stated in claim 1, where the work forum is hosted on a server connected to internet and can be accessed through a computer system like a laptop, a tablet, a Personal Computer, a Phablet or a mobile phone or any other similar device that permits data sharing and internet connectivity.

4. The method as stated in claim 1, where the step of allowing user to define work description is carried out by means of a software capture tool that captures the user specified work description and triggers a new set of possible choices in response to the choice of the user made in the prior filter.

5. The method as stated in claim 1, where the database of vetted workers includes a software capture tool that conducts vetting of new workers signing up with the platform.

6. The method as stated in claim 1, where the attributes for vetting workers without limitation includes qualification, work ethics, language and communication skills, communication technology, availability, references, test work, preferred standard work definition proposed by the worker.

7. The method as stated in claim 1, where the continuous evaluation of workers is a combined feedback which is generated from work assignors, platform employees, machine algorithm, other workers the work shared with and self-evaluation feedback from worker himself.

8. The method as stated in claim 1, where the Standard work definition is the list of standard jobs pre-existing in the database.

9. The method as stated in claim 1, where the step of automatic allotment of work to worker through machine learning algorithms further comprises the step of:
a. Matching the requested new work to the standard work definitions to calculate the project fit rate;
b. Matching of the vetted workers against the standard work definitions to calculate worker suitability;
c. Propose the worker that best fits to the work

10. The method as stated in claim 1, wherein the step of deciding between an automatic matching or manual allotment of work to workers is depended upon variation in the threshold between project fit rate and worker suitability.

11. The method as stated in claim 1, where a manual intervention by platform employee is demanded to assure a perfect match further comprises the step of allotting partially similar or dissimilar work descriptions to a standard work definition and based on the deviation in the threshold for a perfect match, either changing the work descriptions so as to make it in consonance with the existing standard work definition, or creating a new category for the standard work definition so that the requested work meets the project fitness criteria.

12. The method as stated in claim 9, wherein a standard work definition many have one or multiple vetted workers assigned to it.

13. A semi-automated system and method for assigning vetted worker to a new work description, comprising the step of:
a. verifying qualifications and suitability of vetted worker against the designated new work by the machine learning algorithms;
b. verifying the identified vetted worker against the user's preference;
c. assigning favourable vetted worker to the new work.

14. The method as stated in claim 13, where the semi-automated system includes assignment through machine learning algorithms or manual assignment through platform employees or both.

15. The method as stated in claim 14, wherein the assignment of vetted workers to a new work is performed by human intervention further comprising the steps of:
a. notifying the platform employee of no suitable match for new work resulted through system algorithms;
b. manual searching by platform employee for suitable vetted worker on certain given attributes;
assignment of suitable vetted worker to a standard work definition designated under the new work.
